(19) United States
(12) Patent Application Publication
(10) Pub. No.: US 2026/0319287 A1
(43) Pub. Date: Oct. 15, 2026

(54) IMAGE DISPLAY APPARATUS

(71) Applicant: FUJIFILM Corporation, Tokyo (JP)

(72) Inventors: Misato ITO, Minamiashigara-shi, Kanagawa (JP); Masaaki SUZUKI, Minamiashigara-shi, Kanagawa (JP); Hiroshi SATO, Minamiashigara-shi, Kanagawa (JP); Akira MARUYAMA, Minamiashigara-shi, Kanagawa (JP)

(73) Assignee: FUJIFILM Corporation, Tokyo (JP)

(21) Appl. No.: 19/701,802

(22) Filed: Jun. 9, 2026

Related U.S. Application Data
(63) Continuation of application No. PCT/JP2024/044713, filed on Dec. 18, 2024.

(30) Foreign Application Priority Data
Dec. 25, 2023 (JP) 2023-218257

(51) Int. Cl. G02F 1/1335; G02F 1/13357; G02F 1/13363

(52) U.S. Cl. CPC G02F 1/133504; G02F 1/133541; G02F 1/133603; G02F 1/133638

(57) ABSTRACT

An object is to provide an image display apparatus having high color purity of light for displaying an image. The object is achieved by including a plurality of light sources, a spectral element that disperses light emitted from the light sources, and a light shutter array that is disposed on an optical path of the light dispersed by the spectral element and in which a plurality of shutter units are disposed.

### CROSS-REFERENCE TO RELATED APPLICATIONS

This application is a Continuation of PCT International Application No. PCT/JP2024/044713 filed on Dec. 18, 2024, which claims priority under 35 U.S.C. § 119(a) to Japanese Patent Application No. 2023-218257 filed on Dec. 25, 2023. The above applications are hereby expressly incorporated by reference, in their entirety, into the present application.

### BACKGROUND OF THE INVENTION

### 1. Field of the Invention

The present invention relates to an image display apparatus.

### 2. Description of the Related Art

An image display apparatus using a micro electro mechanical systems (MEMS) shutter device without using a color filter has been proposed for a liquid crystal display device using a color filter. In the following description, the image display apparatus using the MEMS shutter device will also be referred to as an “MEMS display apparatus”.

For example, JP2017-15766A describes, as an image display apparatus including a backlight that emits light and a MEMS shutter device that includes an opening portion through which the light emitted from the backlight is transmitted and that opens and closes the opening portion to control the amount of light transmitted through the opening portion, an MEMS display apparatus including, on a viewing side of the MEMS shutter device, an absorptive polarizer and a λ/4 wavelength plate that are sequentially disposed from the viewing side, and a reflective polarizer that is disposed on a backlight side with respect to the λ/4 wavelength plate.

### SUMMARY OF THE INVENTION

In the MEMS display apparatus, by providing the opening portion of the MEMS shutter device on a reflective plate, light emitted from the backlight and not directly directed to the opening portion can be reflected between the reflective plate and the backlight to be directed to the opening portion and transmitted through the opening portion. Therefore, the MEMS display apparatus has a higher utilization efficiency of light emitted from the backlight than a liquid crystal display device.

In addition, since the MEMS display apparatus does not use a color filter, the utilization efficiency of light emitted from the backlight is higher than that of a liquid crystal display device that uses a color filter to disperse white light.

In particular, according to the MEMS display apparatus described in JP2017-15766A, even in a case where a display screen is made to have a high definition, it is possible to significantly suppress external light reflection and improve visibility while maintaining a high utilization efficiency of light and maintaining a high front brightness, and it is possible to achieve both a high front brightness and an improvement in visibility due to suppression of external light reflection.

Here, in the MEMS display apparatus in the related art, an image is displayed by light emitted from a light source of a backlight. Therefore, the color purity of each color emitted by the backlight, that is, the color purity of light used for image display is determined by the light emission spectrum of the light source.

In order to widen the color gamut of the display image, it is advantageous that the color purity of light used for image display is high. However, as described above, in the MEMS display apparatus that does not use a color filter in the related art, the color purity of light of each color emitted by the backlight is determined by the light emission spectrum of the light source.

Therefore, in the MEMS display apparatus that does not use a color filter in the related art, it is difficult to increase the color purity of light used for image display.

An object of the present invention is to solve the above-described problem in the related art, and to provide an image display apparatus that displays an image by turning on/off light of each color with a light shutter array without using a color filter, in which the color purity of light for displaying the image is high.

In order to achieve this object, the present invention has the following configurations.
[1] An image display apparatus comprising:
a plurality of light sources; a spectral element that disperses light emitted from the light sources; and
a light shutter array that is disposed on an optical path of the light dispersed by the spectral element and in which a plurality of shutter units are disposed.
[2] The image display apparatus according to [1], in which the spectral element is any one of a surface relief diffraction element, a hologram, a metasurface, or a liquid crystal diffraction element.
[3] The image display apparatus according to [1] or [2], further comprising: a deflection element that is disposed on a side of the spectral element opposite to the light sources.
[4] The image display apparatus according to any one of [1] to [3], in which the light emitted from the light sources is parallel light.
[5] The image display apparatus according to any one of [1] to [4], in which the light emitted from the light sources includes at least a part of light in a wavelength range of 400 to 480 nm, at least a part of light in a wavelength range of 520 to 570 nm, and at least a part of light in a wavelength range of 620 to 680 nm.
[6] The image display apparatus according to any one of [1] to [5], further comprising: a circular polarization plate that is disposed on a side of the light shutter array opposite to the spectral element.
[7] The image display apparatus according to [6], in which the circular polarization plate includes a λ/4 retardation plate and a linear polarizer, and
the λ/4 retardation plate is a pattern retardation plate having a plurality of regions where phase differences are equal to each other and slow axis directions are different from each other.

According to the image display apparatus of an aspect of the present invention, there is provided an image display apparatus that displays an image by turning on/off light of each color with a light shutter array, in which color purity of light for displaying the image is high.

### BRIEF DESCRIPTION OF THE DRAWINGS

FIG. 1 is a diagram conceptually showing an example of an image display apparatus of an embodiment of the present invention.

FIG. 2 is a front view conceptually showing an example of a liquid crystal diffraction element.

FIG. 3 is a schematic plan view of the liquid crystal diffraction element shown in FIG. 2.

FIG. 4 is a conceptual view showing the action of the liquid crystal diffraction element.

FIG. 5 is a conceptual view showing the action of the liquid crystal diffraction element.

FIG. 6 is a conceptual view showing an example of a light shutter array.

FIG. 7 is a diagram conceptually showing an example of an image display apparatus of an embodiment of the present invention.

### DESCRIPTION OF THE PREFERRED EMBODIMENTS

Hereinafter, an image display apparatus according to an embodiment of the present invention will be described in detail based on suitable examples illustrated in the accompanying drawings.

In the present specification, numerical ranges represented by “to” include numerical values before and after “to” as lower limit values and upper limit values.

In the present specification, “same”, “equal”, and the like include an error range generally accepted in the technical field.

In addition, the present invention is not limited to this, but in the present specification, among visible light, blue light refers to light in a wavelength range of 380 to 490 nm, green light refers to light in a wavelength range of more than 490 nm and 600 nm or less, and red light refers to light in a wavelength range of more than 600 nm and 750 nm or less.

In addition, all of the drawings shown below are conceptual diagrams for describing the image display apparatus according to the present invention. Therefore, a thickness, a size, a shape, a positional relationship, and the like of each member and constituent element may be different from the actual ones.

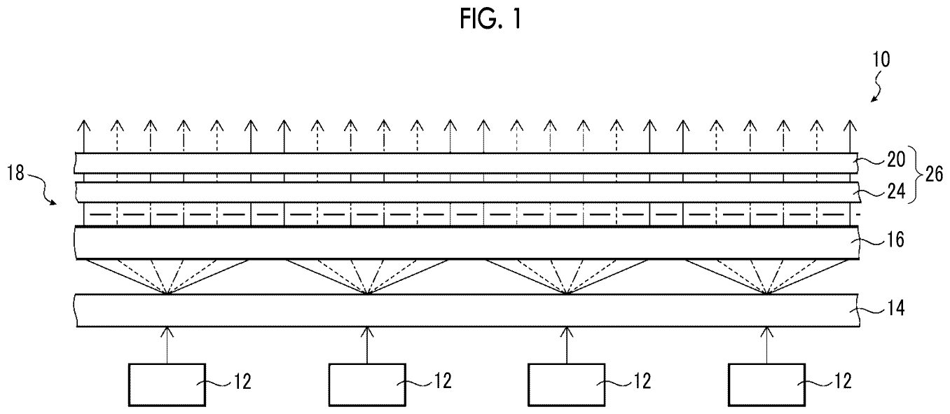

FIG. 1 is a view conceptually showing an example of an image display apparatus according to the present invention.

An image display apparatus 10 shown in FIG. 1 includes light sources 12 that are two-dimensionally arranged, a spectral element 14 that disperses light emitted from the light sources 12, a deflection element 16 that deflects the light dispersed by the spectral element 14, a light shutter array 18, and a circular polarization plate 26. The circular polarization plate 26 includes a linear polarizer 20 and a λ/4 retardation plate 24.

In the present invention, the deflection element 16 and the circular polarization plate 26 are provided as a preferred aspect.

In the image display apparatus 10 shown in FIG. 1, the light sources 12 emit white light as an example.

The white light emitted from the light sources is dispersed into light having each wavelength by the spectral element 14.

The light dispersed by the spectral element 14 is deflected by the deflection element 16 into light in a direction orthogonal to an image display surface of the image display apparatus 10.

The light deflected by the deflection element 16 is incident into the light shutter array 18. The light shutter array 18 has an opening that transmits only red light having a specific wavelength (solid line), green light having a specific wavelength (broken line), and blue light having a specific wavelength (one-dot chain line) used for image display, and shields light other than these light. In addition, a shutter is provided in the opening, and the red light, the green light, and the blue light transmitted through each opening are shielded/transmitted, that is, turned on/off.

The image display apparatus 10 displays an image by turning on/off (modulating) the red light, the green light, and the blue light by the light shutter array 18.

The red light, the green light, and the blue light transmitted through the light shutter array 18 are transmitted through the circular polarization plate 26 including the λ/4 retardation plate 24 and the linear polarizer 20, are emitted from the image display apparatus 10, and display an image.

In the image display apparatus 10 according to the embodiment of the present invention, as an example, the light sources 12 are two-dimensionally arranged in two orthogonal directions (x-y direction).

The arrangement of the light sources 12 is not limited, and may be appropriately set depending on, for example, a pixel arrangement for image display in the image display apparatus 10 and the dispersion of light by the spectral element 14. Accordingly, the arrangement of the light sources 12 may be regular or irregular, but is usually regularly arranged in two orthogonal directions (x-y direction). An arrangement interval of the light sources 12 in the x direction and an arrangement interval of the light sources 12 in the y direction may be the same as or different from each other.

In the image display apparatus 10 according to the present invention, the light source 12 is not limited, and various known light sources can be used.

Examples of the light source 12 include a light source in which a plane light source such as a light source formed by arranging a light emitting diode (LED), an organic electro-luminescence (EL) light emitting element, a laser light source, and a fluorescent lamp, and a light shielding plate on which a plurality of pinholes are formed are combined.

In addition, the light source may be a white light source such as a white LED or a white organic EL light emitting element, or may be a monochromatic light source such as a red light source, a green light source, or a blue light source. In addition, in a case where the monochromatic light source is used, a plurality of types of light sources may be used, such as three types of light sources including the red light source, the green light source, and the blue light source.

As the light source 12, a white light source is suitably used. As described above, in FIG. 1, the light source 12 is a white light source.

Specifically, as the light source 12, a light source that emits light including red light, green light, and blue light is suitably used. More preferably, the light source 12 emits light including at least a part of light in a wavelength range of 400 to 480 nm, at least a part of light in a wavelength range of 520 to 570 nm, and at least a part of light in a wavelength range of 620 to 680 nm.

It is preferable to use a light source that emits light in such a wavelength range as the light source 12 from the viewpoint that a full color image can be displayed, an image having good color reproducibility can be displayed, and color unevenness of a display image can be reduced.

In addition, in the image display apparatus 10 according to the present invention, it is preferable that the light source 12 is a light source that emits parallel light instead of diffused light.

It is preferable that the light source 12 emits parallel light from the viewpoint that image display using light having higher color purity is possible and the utilization efficiency of light is increased.

As the light source 12 that emits parallel light, various known light sources that emit parallel light, such as a commercially available parallel light source (collimated light source, collimated light) and a light source in which a light emitting element that emits diffused light and a collimating lens are combined, can be used.

In the image display apparatus 10, the light emitted from the light source 12 is dispersed into light of each wavelength by the spectral element 14.

As the spectral element 14, various known transmissive spectral elements that disperse incident ray according to the wavelength can be used. Examples of the spectral element 14 include various transmissive diffraction elements such as a surface relief diffraction element having unevenness corresponding to a periodic structure as a diffraction element on a surface, a hologram that is prepared to diffract visible light using a known method such as a computer-generated hologram and interference exposure, a metasurface (metasurface structure or metamaterial) in which microstructures (resonators) having a size corresponding to the wavelength of diffracted light are arranged, and a liquid crystal diffraction element described later. Various known diffraction elements can be used as these diffraction elements.

Among these, a metasurface and a liquid crystal diffraction element are particularly suitable from the viewpoint of the utilization efficiency of light related to a circular polarization plate 26 described later, and a liquid crystal diffraction element is particularly suitable.

In the image display apparatus 10 shown in FIG. 1, the spectral element 14 is a liquid crystal diffraction element.

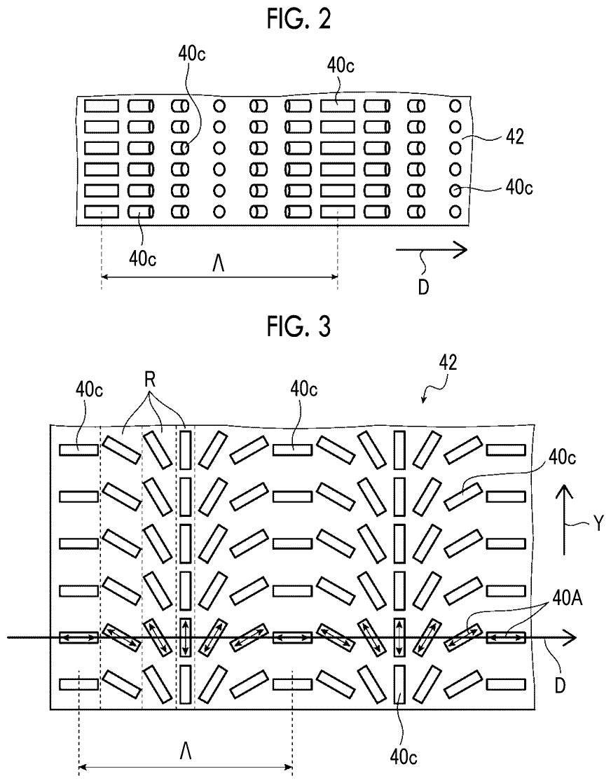

FIGS. 2 and 3 conceptually show an example of a liquid crystal diffraction element 42 as the spectral element 14.

FIG. 2 is a front view of the liquid crystal diffraction element 42, and FIG. 3 is a plan view thereof. The front view is a view of the liquid crystal diffraction element 42 in a plane direction of a main surface, and the plan view is a view of the liquid crystal diffraction element 42 in a direction orthogonal to the main surface, that is, in a normal direction. Furthermore, the main surface is the maximum surface of a sheet-like material (a plate-like material, a film, or a layer), and is usually on both sides in the thickness direction.

The liquid crystal diffraction element 42 is a cured layer of a liquid crystal composition including a liquid crystal compound, that is, a liquid crystal layer (optically anisotropic layer).

The spectral element 14 including the liquid crystal diffraction element 42 may include an alignment film for aligning the liquid crystal compound of the liquid crystal diffraction element 42 (liquid crystal layer) and/or a support layer for supporting the liquid crystal diffraction element, or may include other layers as necessary.

The liquid crystal diffraction element 42 is a liquid crystal layer obtained by immobilizing a liquid crystal phase in which a liquid crystal compound 40c is aligned, and is a liquid crystal layer having a liquid crystal alignment pattern in which an orientation of an optical axis 40A derived from the liquid crystal compound 40c changes while continuously rotating in at least one in-plane direction.

The optical axis 40A derived from the liquid crystal compound 40c is an axis having a highest refractive index in the liquid crystal compound 40c, that is, a so-called slow axis.

In FIGS. 2 and 3, since a rod-like liquid crystal compound is shown as the liquid crystal compound 40c, the optical axis 40A is along a major axis direction of a rod shape. In a case where the liquid crystal compound is a disk-like liquid crystal compound, the optical axis derived from the disk-like liquid crystal compound is a direction perpendicular to a disc plane of the disk-like liquid crystal compound.

In the following description, the “optical axis derived from the liquid crystal compound” is also simply referred to as an “optical axis of the liquid crystal compound” or an “optical axis”.

As shown in FIG. 3, the liquid crystal compound 40c forming the liquid crystal diffraction element 42 has a liquid crystal alignment pattern in which the orientation of the optical axis 40A changes while continuously rotating in a predetermined direction indicated by an arrow D (hereinafter, referred to as an array axis D) in a plane of the liquid crystal diffraction element 42. In the example shown in the drawing, the liquid crystal compound 40c has the liquid crystal alignment pattern in which the optical axis 40A of the liquid crystal compound 40c changes while continuously rotating clockwise in the array axis D direction.

The liquid crystal compound 40c forming the liquid crystal diffraction element 42 is two-dimensionally arranged in the array axis D and a direction orthogonal to the one direction (array axis D direction).

In the following description, a direction orthogonal to the array axis D direction will be referred to as a “Y direction” for convenience of description. That is, the arrow Y direction is a direction orthogonal to the one direction in which the orientation of the optical axis 40A of the liquid crystal compound 40c changes while continuously rotating in the plane of the liquid crystal diffraction element 42.

In FIGS. 1 to 7, the array axis D direction is a horizontal direction in the drawing. Therefore, in FIGS. 1, 2, and 4 to 7, the Y direction is a direction orthogonal to the paper plane.

Specifically, the orientation of the optical axis 40A of the liquid crystal compound 40c changes while continuously rotating in the array axis D direction (the predetermined one direction) means that an angle between the optical axis 40A of the liquid crystal compound 40c, which is arranged in the array axis D direction, and the array axis D direction varies depending on positions in the array axis D direction, and the angle between the optical axis 40A and the array axis D direction sequentially changes from θ to θ+180° or θ−180° in the array axis D direction.

In the liquid crystal diffraction element 42 shown in FIGS. 2 and 3, as an example, the optical axis 40A of the liquid crystal compound 40c rotates rightward (clockwise) in the array axis D direction.

On the other hand, in the liquid crystal compound 40c forming the liquid crystal diffraction element 42, the orientations of the optical axes 40A are the same in the Y direction orthogonal to the array axis D direction, that is, the Y direction orthogonal to the one direction in which the optical axis 40A changes while continuously rotating.

In other words, in the liquid crystal compound 40c forming the liquid crystal diffraction element 42, the angles between the optical axes 40A of the liquid crystal compound 40c and the array axis D direction are the same in the Y direction. Regions in which the liquid crystal compounds 40c in which the angles between the optical axes 40A and the array axis D direction are the same are disposed in the Y direction will be referred to as “regions R”.

As described above, in the liquid crystal diffraction element 42, in the liquid crystal alignment pattern of the liquid crystal compound 40c, a length (length Λ (distance)) over which the optical axis 40A of the liquid crystal compound 40c rotates by 180° in the array axis D direction in which the optical axis 40A changes while continuously rotating in the plane is set as the single period Λ in the liquid crystal alignment pattern.

That is, a distance between centers of two liquid crystal compounds 40c in the array axis D direction, in which the angles with respect to the array axis D direction are the same, is set as the single period Λ. Specifically, as shown in FIGS. 2 and 3, a distance between centers of two liquid crystal compounds 40c in the array axis D direction, in which the array axis D direction and the direction of the optical axis 40A match with each other, is set as the single period Λ.

In the liquid crystal alignment pattern of the liquid crystal diffraction element 42, the single period Λ is repeated in the array axis D direction, that is, the one direction in which the orientation of the optical axis 40A changes while continuously rotating. In the liquid crystal diffraction element 42 having such a liquid crystal alignment pattern, the single period Λ is the single period of the periodic structure in the diffraction element.

The liquid crystal diffraction element 42 having such a liquid crystal alignment pattern diffracts (refracts) and transmits incident circularly polarized light along the array axis D and converts the polarization direction of the circularly polarized light.

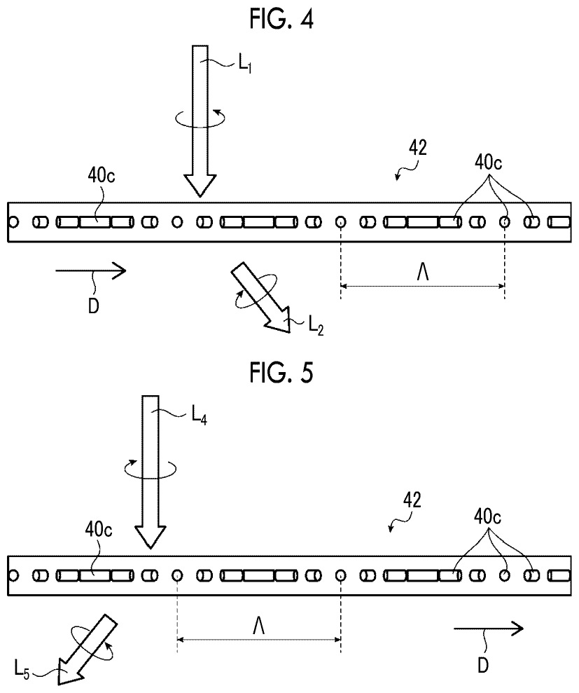

In the liquid crystal diffraction element 42, it is assumed that the value of the product of the difference in refractive index of the liquid crystal compound and the thickness of the image display apparatus is λ/2. In addition, in FIGS. 4 and 5, only the liquid crystal compound 40c on the surface is shown in order to show the rotation direction of the optical axis in the liquid crystal alignment pattern of the liquid crystal diffraction element 42, but the liquid crystal diffraction element 42 includes the laminated liquid crystal diffraction elements 42 as shown in FIG. 2.

As shown in FIG. 4, in a case where the value of the product of the difference in refractive index of the liquid crystal compound of the liquid crystal diffraction element 42 and the thickness of the liquid crystal diffraction element 42 is λ/2 and incident ray L₁ as left circularly polarized light is incident into the liquid crystal diffraction element 42, the incident ray L₁ transmits through the liquid crystal diffraction element 42 and is imparted with a phase difference of 180° so that the transmission ray L₂ is converted into right circularly polarized light.

In addition, since the liquid crystal alignment pattern formed in the liquid crystal diffraction element 42 is a pattern that is periodic in the array axis D direction, the transmission rays L₂ travel in a direction different from a traveling direction of the incident rays L₁. In this way, the left circularly polarized incident rays L₁ are converted into right circularly polarized transmission rays L₂, which are tilted by a predetermined angle in the array axis D direction with respect to an incident direction.

On the other hand, as shown in FIG. 5, in a case where the value of the product of the difference in refractive index of the liquid crystal compound of the liquid crystal diffraction element 42 and the thickness of the liquid crystal diffraction element 42 is λ/2 and incident ray L₄ as right circularly polarized light is incident into the liquid crystal diffraction element 42, the incident ray L₄ transmits through the liquid crystal diffraction element 42 and is imparted with a phase difference of 180° so that the incident ray L₄ is converted into transmission ray L₅ as left circularly polarized light.

In addition, since the liquid crystal alignment pattern formed in the liquid crystal diffraction element 42 is a pattern that is periodic in the array axis D direction, the transmission rays L₅ travel in a direction different from a traveling direction of the incident rays L₄. In this case, the transmission rays L₅ travel in a direction different from the transmission rays L₂, that is, in a direction opposite to the arrow direction of the array axis D direction with respect to the incident direction. In this way, the incident rays L₄ are converted into left circularly polarized transmission rays L₅, which are tilted by a predetermined angle in a direction opposite to the array axis D direction with respect to the incident direction.

As in various diffraction elements, in the liquid crystal diffraction element 42, the diffraction angles of the transmission ray L₂ and the transmission ray L₅ can be adjusted by the length of the single period Λ of the formed liquid crystal alignment pattern.

Specifically, in the liquid crystal diffraction element 42, as the single period Λ of the liquid crystal alignment pattern decreases, light transmitted through the liquid crystal compounds adjacent to each other more strongly interfere with each other. Therefore, the transmission rays L₂ and L₅ can be more largely diffracted (refracted).

By reversing the rotation direction of the optical axis 40A of the liquid crystal compound that rotates in the array axis D direction, the diffraction direction of the transmission ray can be reversed.

That is, in the example shown in FIGS. 4 and 5, the rotation direction of the optical axis 40A toward the array axis D direction is clockwise. By setting this rotation direction to be counterclockwise, the diffraction direction of transmission ray can be reversed.

Accordingly, in a case where unpolarized light is incident into the liquid crystal diffraction element 42, the light is refracted in opposite directions between the component of right circularly polarized light and the component of left circularly polarized light.

In the examples shown in FIGS. 4 and 5, the component of left circularly polarized light is converted into right circularly polarized light and is refracted in the left direction (array axis D direction) in FIG. 1, and the component of right circularly polarized light is converted into left circularly polarized light and is refracted in the right direction in FIG. 1.

As is well known, in a transmissive diffraction element, the diffraction angle (refraction angle) of transmission ray depends on the wavelength of incident ray. As in various diffraction elements, in the liquid crystal diffraction element 42, the diffraction angle of transmission ray depends on the wavelength of incident ray.

Specifically, in the transmissive diffraction element, as the wavelength of incident ray increases, the diffraction angle of transmission ray increases. Accordingly, in a case where light in a certain wavelength range is incident into the liquid crystal diffraction element 42 (diffraction element), the incident ray is dispersed in the repetition direction of the periodic structure of the diffraction element, that is, the array axis D direction according to the wavelength, and light having a long wavelength is largely diffracted, and light having a short wavelength is transmitted at a small diffraction angle and travels in different directions.

That is, in the image display apparatus 10 shown in FIG. 1, white light emitted from the light sources 12 and incident into the spectral element 14 is dispersed in the array axis D direction by the spectral element 14 (liquid crystal diffraction element 42), and red light (solid line) travels in a different direction at a large diffraction angle, blue light (one-dot chain line) travels in a different direction at a small diffraction angle, and green light (broken line) travels in a different direction at a diffraction angle between the large diffraction angle and the small diffraction angle. In FIG. 1, the array axis D direction, that is, the spectral direction of light is a horizontal direction in the drawing.

In addition, even when the light is of the same color, the light is dispersed in the array axis D direction according to the wavelength, and light having a long wavelength travels in a different direction at a large diffraction angle, and light having a short wavelength travels in a different direction at a small diffraction angle. For example, in a case of red light having a wavelength of 620 to 680 nm, light having a wavelength of 620 nm travels in a different direction at the smallest diffraction angle, light having a wavelength of 680 nm travels in a different direction at the largest diffraction angle, and light having a wavelength of 650 nm travels in a different direction at a diffraction angle between the smallest diffraction angle and the largest diffraction angle.

As described above, the diffraction angle can be adjusted by the length of the single period Λ.

As described above, in the image display apparatus 10 of the example shown in the drawing, the liquid crystal diffraction element 42 is used as the spectral element 14. Therefore, light incident into the spectral element 14, that is, the liquid crystal diffraction element 42 is dispersed by being separated into right circularly polarized light and left circularly polarized light according to circularly polarized light components.

Accordingly, in the image display apparatus 10 of the example shown in the drawing, one light source 12 corresponds to two pixels of the image, where each pixel consists of three sub pixels of red, green, and blue in the spectral direction of light, that is, the diffraction direction of light. On the other hand, one light source 12 corresponds to one pixel of the image in a direction orthogonal to the spectral direction of light.

As described above, the spectral direction of light, that is, the diffraction direction of light is the one direction in which the optical axis 40A in the liquid crystal alignment pattern of the liquid crystal diffraction element 42 changes while continuously rotating, that is, the array axis D direction.

The light dispersed by the spectral element 14 is then incident into the deflection element 16. That is, the deflection element 16 is disposed on a side of the spectral element 14 opposite to the light sources 12.

As conceptually shown in FIG. 1, the deflection element 16 is an element that deflects the traveling direction of light dispersed by being diffracted by the spectral element 14 in a direction (normal direction) orthogonal (substantially orthogonal) to the display surface of the image display apparatus 10. In other words, the deflection element 16 is an element that emits light of each wavelength dispersed by being diffracted by the spectral element 14 in a direction orthogonal to the display surface of the image display apparatus 10 as a maximal direction of an intensity distribution.

In the image display apparatus 10 of the example shown in the drawing, as an example, the display surface is a main surface of the linear polarizer 20 forming the circular polarization plate 26.

By including such a deflection element 16, it is possible to emit light, that is, an image in the front direction in the image display apparatus 10.

The deflection element 16 is provided as a preferred aspect and is not an essential configuration requirement in the image display apparatus according to the present invention. That is, in the image display apparatus 10 according to the present invention, the light dispersed by the spectral element 14 may be used for image display without being deflected in the traveling direction.

In addition, in the image display apparatus according to the present invention, the disposition position of the deflection element 16 is not limited to between the spectral element 14 and the light shutter array 18, and may be, for example, between the light shutter array 18 and the circular polarization plate 26.

That is, the deflection element 16 may be disposed downstream of the spectral element 14. The downstream is downstream in the traveling direction of light emitted from the light sources 12.

In the image display apparatus 10 according to the present invention, the deflection element 16 is not limited, and various well-known optical elements can be used as long as the optical elements can refract or diffract incident ray to deflect the traveling direction of light incident from an oblique direction to a direction orthogonal to the display surface of the image display apparatus 10.

Examples thereof include various optical elements that refract light, such as a prism, a cylindrical lens, a prism sheet, and a lenticular lens.

In addition, a diffraction element such as a transmissive surface relief diffraction element and a transmissive hologram can also be used as the deflection element 16.

Further, in a case where the spectral element 14 is a diffraction element that diffracts circularly polarized light in a direction opposite to the revolution direction as in the liquid crystal diffraction element 42 in the example shown in the drawing, the same spectral element 14 (diffraction element) can also be used as the deflection element 16.

For example, the liquid crystal diffraction element 42 as the above-described spectral element 14 converts left circularly polarized light into right circularly polarized light and diffracts the right circularly polarized light in a left direction in FIG. 1 and converts right circularly polarized light into left circularly polarized light and diffracts the left circularly polarized light in a right direction in FIG. 1. Accordingly, by using the same liquid crystal diffraction element 42 as the deflection element 16, right circularly polarized light traveling in the left direction in the drawing is converted into left circularly polarized light and diffracted in the right direction in the drawing, and left circularly polarized light traveling in the right direction in the drawing is converted into right circularly polarized light and diffracted in the left direction in the drawing.

As a result, light transmitted through the deflection element 16 can be deflected in a direction orthogonal to the display surface of the image display apparatus 10.

The light deflected by the deflection element 16 is then incident into the light shutter array 18.

The light shutter array 18 is a light shutter array that transmits or shields only light having a predetermined wavelength (wavelength range) and shields light having other wavelengths in each of red light, green light, and blue light that are dispersed by the spectral element 14 and incident into the light shutter array 18.

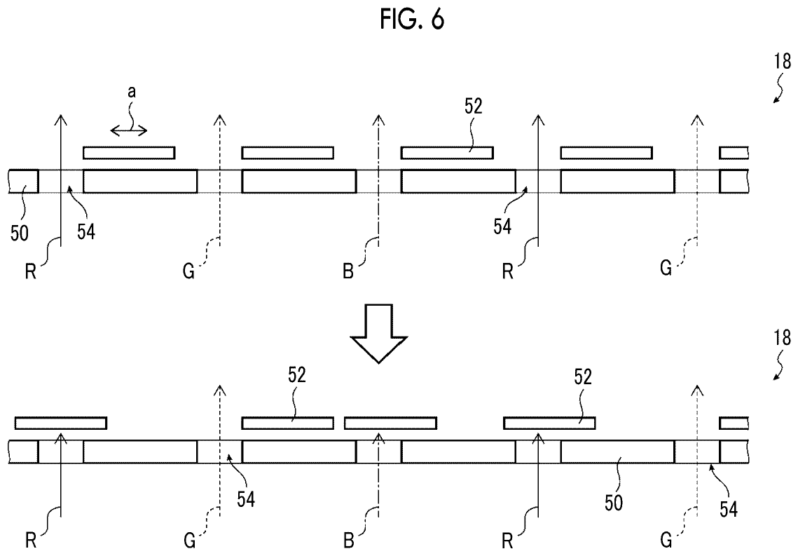

FIG. 6 conceptually shows an example of the light shutter array 18.

The light shutter array 18 shown in FIG. 6 is a light shutter array using a micro electro mechanical systems (MEMS) shutter device and includes a substrate 50 and a shutter member 52. The substrate 50 is provided with openings 54 at predetermined intervals. The openings 54 are two-dimensionally formed in, for example, a square grid pattern, and one shutter member 52 is provided in one opening 54. The shutter member 52 is a plate-shaped light shielding member that shields light passing through the openings 54. In the example shown in the drawing, one opening 54 and one shutter member 52 constitute a shutter unit in the present invention.

In addition, in the substrate 50, a region other than the openings 54 is, for example, black or the like over the entire surface, and shields or preferably absorbs incident light.

As described above, in the image display apparatus 10 shown in FIG. 1, the light sources 12 emit white light, and the spectral element 14 disperses right circularly polarized light and left circularly polarized light into red light, green light, and blue light, respectively.

Accordingly, in the image display apparatus 10 shown in FIG. 1, the substrate 50 has six openings 54 for one light source 12 in the spectral direction (array axis D direction) of light. In addition, one opening 54 is provided for one light source 12 in a direction (arrow y direction in FIG. 3) orthogonal to the spectral direction of light, that is, a direction perpendicular to the paper plane.

As shown in FIG. 6, in the light shutter array 18, the shutter member 52 is moved in a horizontal direction (arrow a direction) in the drawing by MEMS to close/open the openings 54, and red light R indicated by a solid line, green light G indicated by a broken line, and blue light B indicated by a one-dot chain line, which are incident on the openings 54, are respectively shielded or transmitted. That is, the light shutter array 18 turns on/off the light incident on the openings 54 by moving the shutter member 52.

For example, in a case where a monochromic image of green is displayed in the image display apparatus 10, as shown in the lower part of FIG. 6, the openings 54 through which the red light R passes and the openings 54 through which the blue light B passes are closed (off) by the shutter member 52, and only the openings 54 through which the green light G is incident are opened (on).

In the image display apparatus 10 of the example shown in the drawing, the image is displayed by turning on/off the red light R, the green light G, and the blue light B passing through each opening 54 by the light shutter array 18 according to the image to be displayed.

That is, in the image display apparatus 10 of the example shown in the drawing, the image is displayed by modulating the red light R, the green light G, and the blue light B passing through each opening 54 by the light shutter array 18 according to the image to be displayed.

Here, in the image display apparatus 10 according to the present invention, the light incident on the light shutter array 18 is dispersed along the array axis D direction according to the wavelength by the spectral element 14.

Accordingly, the light shutter array 18 is also incident with the light of each wavelength that is dispersed in a region of the substrate 50 other than the openings 54. As described above, the substrate 50 shields the light incident on a region other than the openings 54.

That is, in the image display apparatus 10 according to the present invention, only the light of the wavelength (wavelength range) incident on the openings 54 among the light dispersed by the spectral element 14 is used for the image display.

For example, in the light shutter array 18 shown in FIG. 6, as for the red light, red light R having a wavelength of 630 to 640 nm is incident on the openings 54 and is used for image display, and the red light having other wavelengths is shielded by the substrate 50. In addition, the green light is used for the image display by the green light G having a wavelength of 530 to 540 nm incident on the openings 54, and the green light having other wavelengths is shielded by the substrate 50. Further, the blue light is used for the image display by the blue light B having a wavelength of 450 to 460 nm incident on the openings 54, and the blue light having other wavelengths is shielded by the substrate 50.

As described above, in the image display apparatus 10 according to the present invention, the openings 54 are provided at positions where the light having the wavelength used for the image display is incident in accordance with the light dispersed by the spectral element 14, so that the light having the desired wavelength can be extracted. In addition, the wavelength range of the extracted light can be set by the size of the openings 54 in the spectral direction (array axis D direction) of the light. That is, by reducing the size of the openings 54, the wavelength range of the light passing through can be narrowed.

That is, with the image display apparatus 10 according to the present invention, only the light of the wavelength (wavelength range) used for the image display among the light dispersed by the spectral element 14 can be extracted by the light shutter array 18 and used for the image display.

As a result, with the image display apparatus 10 according to the present invention, an image can be displayed using light having high color purity, and an image having a wide color gamut can be displayed.

In the image display apparatus 10 according to the present invention, the wavelength range of the light extracted by the openings 54 of the light shutter array 18 is not limited, but in order to perform the image display using light having high color purity, it is preferable that the wavelength range is narrow.

Specifically, the wavelength range of the light extracted by the openings 54 of the light shutter array 18 is preferably 1 to 20 nm and more preferably 1 to 10 nm.

As described above, the light shutter array 18 in the example shown in the drawing uses the MEMS shutter device.

In the light shutter array 18 of the image display apparatus 10 according to the present invention, the MEMS shutter device is not limited, and various known MEMS shutter devices such as the MEMS shutter device described in JP2008-533510A, JP2014-182211A, and JP2017-15766A can be used.

In the image display apparatus 10 according to the present invention, the light shutter array is not limited to the light shutter array using the MEMS shutter device in the example shown in the drawing.

That is, in the image display apparatus 10 according to the present invention, various known light shutter arrays such as a liquid crystal shutter array and a lead lanthanum zirconate titanate (PLZT) light shutter array can be used as an example.

The light transmitted through the light shutter array 18 is incident into the circular polarization plate 26. That is, the circular polarization plate 26 is disposed on a side of the light shutter array 18 opposite to the spectral element 14.

In the example shown in the drawing, the circular polarization plate 26 is a known circular polarization plate used as an antireflection plate in various image display apparatus including the linear polarizer 20 on the image display surface side, that is, the outer side and the λ/4 retardation plate 24.

That is, the circular polarization plate 26 converts external light incident into the image display apparatus 10 from the outside into linearly polarized light in a predetermined direction by the linear polarizer 20, and then converts the linearly polarized light into circularly polarized light by the λ/4 retardation plate 24. The circularly polarized light is reflected inside the device, and the revolution direction is reversed to be re-incident into the λ/4 retardation plate 24. Accordingly, the λ/4 retardation plate 24 converts the circularly polarized light, which is re-incident with the reversed revolution direction, into linearly polarized light orthogonal to the incident light. Therefore, the linearly polarized light is shielded by the linear polarizer 20. As a result, the circular polarization plate 26 prevents the reflection of external light.

Accordingly, the linear polarizer 20 and the λ/4 retardation plate 24 forming the circular polarization plate 26 are not limited.

Accordingly, the linear polarizer 20 may be a reflective polarizer or an absorptive polarizer, and various known linear polarizers such as an iodine-based polarizer, a dye-based polarizer using a dichroic dye, a polyene-based polarizer, a wire grid polarizer, and a film obtained by stretching a dielectric multi-layer film as described in JP2011-053705A can be used. In particular, an absorptive polarizer such as an iodine-based polarizer and a dye-based polarizer is suitably used.

Accordingly, as the λ/4 retardation plate 24, various known λ/4 plates such as a stretched polycarbonate film, a stretched norbornene-based polymer film, a transparent film in which inorganic particles having birefringence such as strontium carbonate are included and aligned, a thin film with an inorganic dielectric obliquely deposited on a support, a film in which a polymerizable liquid crystal compound is uniaxially aligned and the alignment is immobilized, and a film in which a liquid crystal compound is uniaxially aligned and the alignment is immobilized can be used.

Here, as in the image display apparatus 10 shown in FIG. 1, in a case where the liquid crystal diffraction element 42 that separates and disperses right circularly polarized light and left circularly polarized light in a case where unpolarized light is incident is used as the spectral element 14, it is preferable that a pattern retardation plate having a plurality of regions where phase differences are the same and directions of slow axes are different from each other is used as the λ/4 retardation plate 24.

In addition, even in a case where a metasurface is used as the spectral element 14, the right circularly polarized light and the left circularly polarized light can be separated and dispersed in a case where unpolarized light is incident, as in the liquid crystal diffraction element, depending on the arrangement of the microstructures. Accordingly, in this case as well, it is preferable that a pattern retardation plate having a plurality of regions where phase differences are the same and directions of slow axes are different from each other is used as the λ/4 retardation plate 24, as in the liquid crystal diffraction element 42 as the spectral element.

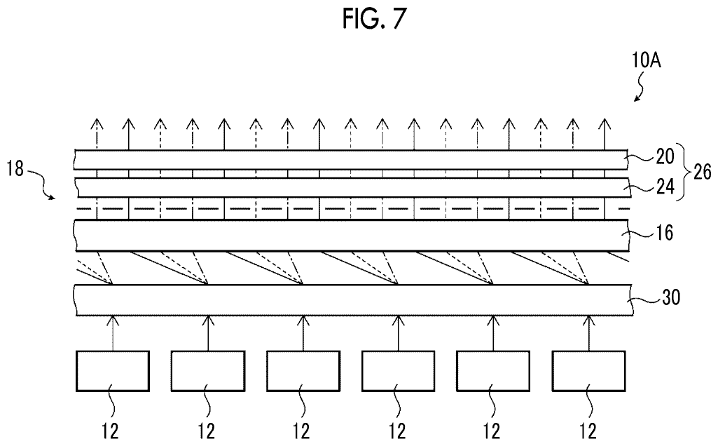

As in an image display apparatus 10A conceptually shown in FIG. 7, in a case where a surface relief diffraction element, a hologram, or the like is used as the spectral element 30, in a case where white light is incident, the spectral element 30 does not separate the incident ray into right circularly polarized light and left circularly polarized light. That is, the dispersed light is unpolarized light and is diffracted in one direction.

In this case, the unpolarized light that has passed through the light shutter array 18 and has been incident into the circular polarization plate 26 is converted into linearly polarized light orthogonal to each other by the λ/4 retardation plate 24, the right circularly polarized light component and the left circularly polarized light component. As a result, any of the linearly polarized light is shielded by the linear polarizer 20.

That is, in this case, the light utilization efficiency of the light that has passed through the light shutter array 18 is halved, and the light utilization efficiency is lowered.

On the other hand, in a case where the liquid crystal diffraction element 42 (metasurface) is used as the spectral element 14, the light that has been dispersed by the spectral element 14 and has passed through the light shutter array 18 includes the right circularly polarized light and the left circularly polarized light that are separated (diffracted) in the opposite direction.

Accordingly, in a case where the liquid crystal diffraction element 42 is used as the spectral element 14, preferably, a pattern retardation plate where phase differences are the same (λ/4) and directions of slow axes are different between a region where the right circularly polarized light is incident and a region where the left circularly polarized light is incident is used as the λ/4 retardation plate 24. Specifically, in the pattern retardation plate, the slow axis is set such that the converted linearly polarized light is transmitted through the linear polarizer 20 in the region where the right circularly polarized light is incident. On the other hand, in the region where the left circularly polarized light is incident, the slow axis is set such that the converted linearly polarized light is transmitted through the linear polarizer 20, and the direction of the slow axis is orthogonal to the direction of the slow axis in the region where the right circularly polarized light is incident.

As a result, in the image display apparatus 10, all of the light that has passed through the light shutter array 18 can be used for image display, and the light utilization efficiency can be improved.

As such a pattern retardation plate, for example, a known pattern retardation plate described in JP2015-45874A, JP2013-11800A, and the like can be used.

The effect of using such a pattern retardation plate is the same in a case where the liquid crystal diffraction element 42 is used as the spectral element and in a case where the metasurface is used.

However, the metasurface has a problem in that the diffraction efficiency is low at wavelengths other than a central wavelength of design.

On the other hand, in a case of the liquid crystal diffraction element, for example, by using a laminated structure where liquid crystal layers are laminated, a high diffraction efficiency can be obtained for light in a wide wavelength range. In consideration of this point, it is preferable to use the liquid crystal diffraction element as the spectral element.

Specifically, as the liquid crystal diffraction element where the liquid crystal layers are laminated, a configuration where liquid crystal layers having a liquid crystal alignment pattern as shown in FIGS. 2 and 3 and in which a liquid crystal compound is helically twisted and aligned by 360° or less in the thickness direction are laminated is exemplified. As an example, a three-layer liquid crystal diffraction element where a liquid crystal layer where a liquid crystal compound is not twisted and aligned in the thickness direction is provided between two liquid crystal layers having the same twisted angle of a helical liquid crystal compound and opposite twisted directions (right-handed twist and left-handed twist) is suitably exemplified. Such a liquid crystal diffraction element is described in detail in WO2022/050321A and the like.

The image display apparatus according to the present invention has been described above in detail, but the present invention is not limited to the above-described examples, and various improvements and changes may be made without departing from the scope of the present invention.

The present invention can be suitably used for various image displays.

### Explanation of References

10, 10A: image display apparatus
12: light source
14, 30: spectral element
16: deflection element
18: light shutter array
20: linear polarizer
24: λ/4 retardation plate
26: circular polarization plate
40A: optical axis
40c: liquid crystal compound
42: liquid crystal diffraction element
50: substrate
52: shutter member
54: opening
R: red light
G: green light
B: blue light
D: array axis
R: region
Λ: single period
L₁, L₄: incident ray
L₂, L₅: transmission ray

What is claimed is:

1. An image display apparatus comprising: a plurality of light sources;
a spectral element that disperses light emitted from the light sources; and
a light shutter array that is disposed on an optical path of the light dispersed by the spectral element and in which a plurality of shutter units are disposed.

2. The image display apparatus according to claim 1, wherein the spectral element is any one of a surface relief diffraction element, a hologram, a metasurface, or a liquid crystal diffraction element.

3. The image display apparatus according to claim 1, further comprising: a deflection element that is disposed on a side of the spectral element opposite to the light sources.

4. The image display apparatus according to claim 1, wherein the light emitted from the light sources is parallel light.

5. The image display apparatus according to claim 1, wherein the light emitted from the light sources includes at least a part of light in a wavelength range of 400 to 480 nm, at least a part of light in a wavelength range of 520 to 570 nm, and at least a part of light in a wavelength range of 620 to 680 nm.

6. The image display apparatus according to claim 1, further comprising: a circular polarization plate that is disposed on a side of the light shutter array opposite to the spectral element.

7. The image display apparatus according to claim 6, wherein the circular polarization plate includes a λ/4 retardation plate and a linear polarizer, and
the λ/4 retardation plate is a pattern retardation plate having a plurality of regions where phase differences are equal to each other and slow axis directions are different from each other.

8. The image display apparatus according to claim 2, further comprising: a deflection element that is disposed on a side of the spectral element opposite to the light sources.

9. The image display apparatus according to claim 2, wherein the light emitted from the light sources is parallel light.

10. The image display apparatus according to claim 2, wherein the light emitted from the light sources includes at least a part of light in a wavelength range of 400 to 480 nm, at least a part of light in a wavelength range of 520 to 570 nm, and at least a part of light in a wavelength range of 620 to 680 nm.

11. The image display apparatus according to claim 2, further comprising: a circular polarization plate that is disposed on a side of the light shutter array opposite to the spectral element.

12. The image display apparatus according to claim 11, wherein the circular polarization plate includes a λ/4 retardation plate and a linear polarizer, and
the λ/4 retardation plate is a pattern retardation plate having a plurality of regions where phase differences are equal to each other and slow axis directions are different from each other.

13. The image display apparatus according to claim 3, wherein the light emitted from the light sources is parallel light.

14. The image display apparatus according to claim 3, wherein the light emitted from the light sources includes at least a part of light in a wavelength range of 400 to 480 nm, at least a part of light in a wavelength range of 520 to 570 nm, and at least a part of light in a wavelength range of 620 to 680 nm.

15. The image display apparatus according to claim 3, further comprising: a circular polarization plate that is disposed on a side of the light shutter array opposite to the spectral element.

16. The image display apparatus according to claim 15, wherein the circular polarization plate includes a λ/4 retardation plate and a linear polarizer, and
the λ/4 retardation plate is a pattern retardation plate having a plurality of regions where phase differences are equal to each other and slow axis directions are different from each other.

17. The image display apparatus according to claim 4, wherein the light emitted from the light sources includes at least a part of light in a wavelength range of 400 to 480 nm, at least a part of light in a wavelength range of 520 to 570 nm, and at least a part of light in a wavelength range of 620 to 680 nm.

18. The image display apparatus according to claim 4, further comprising: a circular polarization plate that is disposed on a side of the light shutter array opposite to the spectral element.

19. The image display apparatus according to claim 18, wherein the circular polarization plate includes a λ/4 retardation plate and a linear polarizer, and
the λ/4 retardation plate is a pattern retardation plate having a plurality of regions where phase differences are equal to each other and slow axis directions are different from each other.

20. The image display apparatus according to claim 5, further comprising: a circular polarization plate that is disposed on a side of the light shutter array opposite to the spectral element.
